(19) United States
(12) Patent Application Publication
(10) Pub. No.: US 2023/0060211 A1
(43) Pub. Date: Mar. 2, 2023

(54) System and Method for Tracking Moving Objects by Video Data

(71) Applicant: ITV Group LLC, Moskva (RU)

(72) Inventors: Vardan Taronovich Margarian, Maykop (RU); Grigorii Olegovich Alekseenko, Irkutsk (RU); Nur Adibovich Tsei, Maykop (RU); Egor Petrovich Suchkov, Tuapse (RU); Nikita Viktorovich Voronchev, Moscow (RU)

(73) Assignee: ITV Group LLC, Moskva (RU)

(21) Appl. No.: 17/823,403

(22) Filed: Aug. 30, 2022

(30) Foreign Application Priority Data
Sep. 1, 2021 (RU) 2021125873

(51) Int. Cl. G06T 7/292; G06T 7/60; G06V 10/44; G06V 10/74; G06V 20/52

(52) U.S. Cl. CPC G06T 7/292; G06T 7/60; G06V 10/44; G06V 10/761; G06V 20/52; G06T 2207/20084; G06T 2207/30241; G06V 2201/07

(57) ABSTRACT

The present invention relates to the field of video surveillance, and more specifically to systems and methods for processing video data obtained from video cameras to track the movement of objects. The system for tracking the moving objects containing: memory; several video cameras; at least one data processing device configured to perform steps including: linking each video camera of the system to the terrain map; calibration of each video camera linked to the terrain map; receiving video data from each video camera calibrated and linked to the terrain map in real time; detecting at least one moving object in the frame of video data received from the first video camera; assigning a unique identification number (ID) to this object detected in the frame; analyzing the geometry of movement, followed by assessment of its direction of motion; predicting the second video camera, in the field of view of which the mentioned object may appear. The technical result of the claimed group of inventions is to improve the accuracy and speed of tracking the moving objects.

### RELATED APPLICATIONS

This application claims priority to Russian Pat. Application No. RU2021125873, filed September, 1, 2021, which is incorporated herein by reference 5 in its entirety.

### FIELD OF THE INVENTION

The present invention relates to the field of video surveillance, and more specifically to systems and methods for processing video data obtained from video cameras to track the movement of objects.

### BACKGROUND

Video surveillance systems means software and hardware or technical means that use computer vision methods for automated data collection, based on the analysis of streaming video (video analysis). Video surveillance systems rely on image processing and image recognition algorithms that allow video analysis without direct human involvement.

Video surveillance systems, depending on specific purposes, can implement many functions, such as, but not limited to: object detection, object movement tracking, object tracking, object classification, object identification, recognition of various objects or situations, and much more.

The tasks that can be solved by video surveillance systems include tracking the movement (movement) of objects through the use of multiple cameras located in the control area, as well as predicting the camera in whose field of view may appear moving object, after leaving the field of view of the current video camera, the video image from which is currently viewed by the operator.

There are many systems known in the background that can track the movement of objects using video data, including in real time. Systems capable of predicting/calculating the direction of objects’ movement have been widely used. With such systems, it is possible to select an object of interest and track its movement over time by multiple video cameras (and not only by data from cameras, but also by data from various sensors). Pat. RU 2670429 C1 publ. Oct. 23, 2018 can serve as an example.

Also, from the background, we know the solution disclosed in application US 20050265582A1, H04N 7/181, publ. Dec. 1, 2005, which discloses a method of video analysis comprising: receiving a set of video frames generated by a set of image sensors, each having a different field of view from a common secured area; and simultaneously tracking, regardless of calibration, of: (i) a set of objects in a controlled environment as objects move between fields of view, at least two of which overlap, and (ii) a set of objects in one field of view based on a set of obtained series of video frames.

However, all solutions known from the background have one significant drawback, which greatly slows down data analysis, for example, searching for objects based on data from cameras and/or sensors. The object tracker used in the video surveillance system detects moving objects in the frame, after which a unique ID is assigned to each object. However, when an object leaves the field of view of one video camera and appears in the field of view of the next video camera, from the perspective of the next camera the object is detected as a new one and a new ID (different from the previous one) is assigned to it accordingly. That is, in general, the video surveillance system does not see any connection between these objects, although the object may be the same.

This disadvantage directly affects the speed of video data search, since the video surveillance system continuously has to analyze a huge number of moving objects with different IDs and try to match them according to some predefined search conditions. For more information about the search and the search criteria specified, see Pat. RU 2710308 C1, publ. Dec. 25, 2019.

From the background, we also know the solution, disclosed in Pat. US 9710716 B2, G06K 9/00, publ. Jul. 7, 2017, describing a computer vision system that performs the following steps: obtaining a data set and providing a series of video frames obtained from the mentioned data; building a bitmap of motion from a series of video frames in a motion detection module; building a raster foreground image from a series of video frames in the background subtraction module; identification of one or more areas in a series of frames, each of which corresponds to an object of the specified category, and tracking of one or more areas in several frames of a series of video frames by the object tracking module, based on a comparison of the motion bitmap and the foreground bitmap. Further, from the monitored areas, the object classifier module determines whether each of the identified areas includes an object of the specified category. Thus, the classifier module can be implemented using a neural network (which is described in more detail in Pat. US 10002313 B2, publ. Jun. 19, 2018).

Our claimed solution is mainly aimed at improving the agility, speed and accuracy of the search by video data, which, in turn, will enable building more complex search conditions, while reducing the search time. These points are of great importance for security systems.

Thus, the main purpose of the claimed invention is to provide a video surveillance system capable of correlating the same object in the field of view of different video cameras. This provides the ability to quickly track the movement of objects in protected areas of any size/scale (e.g., an entire district or city, etc.) throughout its territory.

It should also be noted that the use of neural networks in various tasks, including in video surveillance systems, has become widespread recently.

In general, an artificial neural network (ANN) is a mathematical model, as well as its hardware and/or software implementation, built on the principle of organization and functioning of biological neural networks (networks of nerve cells of living organisms). One of the main advantages of the ANN is their ability to learn, during which the ANN is able to independently identify complex dependencies between input and output data.

It is the use of ANNs for video data processing, as well as the use of standard video surveillance and data processing tools, that makes the claimed solution easier to implement and more accurate compared to solutions known from the background of the invention.

### DISCLOSURE OF THE INVENTION

This technical solution is aimed to eliminate the disadvantages of the previous background of the invention and develop the existing solutions.

The technical result of the claimed group of inventions is to improve the accuracy and speed of tracking the moving objects.

This technical result is achieved by the fact that the system for tracking the moving objects containing: memory configured to store video data and its metadata; several video cameras configured to receive real-time video data from the control area, each with an object tracker; at least one data processing device configured to perform steps including: linking each video camera of the system to the terrain map; calibration of each video camera linked to the terrain map; receiving video data from each video camera calibrated and linked to the terrain map in real time; detecting at least one moving object in the frame of video data received from the first video camera; assigning a unique identification number (ID) to this object detected in the frame; analyzing the geometry of movement detected in the frame of at least one object, followed by assessment of its direction of motion; predicting the second video camera, in the field of view of which the mentioned object may appear; thus, in the case when the field of view of the first and second video cameras do not intersect, the following operations are performed: detecting at least one object in the field of view of the second video camera after the object has left the field of view of the first video camera; constructing the first feature vector of the object detected in the frame from the first video camera and the second feature vector of the object detected in the frame from the second video camera using artificial neural network (ANN); comparing the mentioned first and second feature vectors of the object; assigning the same ID to the object detected in the frame of the second video camera as to the object detected in the frame of the first video camera, if the comparison result is greater than or equal to the threshold value previously set by the user.

In another specific version of the stated solution, the fields of view of the first and second video cameras intersect, and if only one moving object appears in the field of view of the said video cameras, the same ID is automatically assigned to this object.

In another specific version of the stated solution, in the case when the fields of view of the first and second video cameras intersect, and if there are several moving objects in the field of view of the said video cameras, then:

an assumed trajectory of movement is constructed for each object detected in the frame of video data received by the first video camera, based on the analysis of the geometry of the object, and the same ID is assigned to the mentioned trajectory and the object itself;

in the case when the constructed movement trajectory of at least one object does not intersect with the other movement trajectories of objects, based on the obtained movement trajectory of the object, the same object is detected in the frame of video data received from the second video camera, followed by assigning it the same ID corresponding to the trajectory of movement.

In another specific version of the stated solution, in the case when the constructed trajectories of several moving objects intersect, the following is performed: feature vectors for each moving object are constructed; the mentioned feature vectors of moving objects detected in the video data of neighboring/adjacent video cameras are compared pairwise; the same ID is assigned to the objects if the comparison result is greater than or equal to the threshold value previously set by the user.

In another specific version of the stated solution, additionally configured to perform object search based on user-defined search parameters

In another specific version of the stated solution, additionally, on the basis of the resulting data received from the ANN, a postanalysis of the ID assignment history is performed to automatically correct errors when assigning IDs to objects in real time.

In another specific version of the stated solution, the mentioned postanalysis is started by the system automatically, with a certain time interval preset by the user, or is executed once the system user starts an object search.

In another specific version of the stated solution, additionally containing means for data input and output, allowing the user of the system to manually reassign object IDs.

In another specific version of the stated solution, additionally containing means for data input and output, allowing the user of the system to set object search parameters and launch the mentioned object search.

This technical result is also achieved by means of the method for tracking the moving objects performed by a computer system containing at least a data processing device, memory and several video cameras, while the method contains the steps at which the following operations are performed: linking each video camera of the system to the terrain map; calibration of each video camera linked to the terrain map; receiving video data from each video camera calibrated and linked to the terrain map in real time; detecting at least one moving object in the frame of video data received from the first video camera; assigning a unique identification number (ID) to this object detected in the frame; analyzing the geometry of movement detected in the frame of at least one object, followed by assessment of its direction of motion; predicting the second video camera, in the field of view of which the mentioned object may appear; thus, in the case when the field of view of the first and second video cameras do not intersect, the following operations are performed: detecting at least one object in the field of view of the second video camera after the object has left the field of view of the first video camera; constructing the first feature vector of the object detected in the frame from the first video camera and the second feature vector of the object detected in the frame from the second video camera using artificial neural network (ANN); comparing the mentioned first and second feature vectors of the object; assigning the same ID to the object detected in the frame of the second video camera as to the object detected in the frame of the first video camera, if the comparison result is greater than or equal to the threshold value previously set by the user.

In another specific version of the stated solution, the fields of view of the first and second video cameras intersect, and if only one moving object appears in the field of view of the said video cameras, the same ID is automatically assigned to this object.

In another specific version of the stated solution, in the case when the fields of view of the first and second video cameras intersect, and if there are several moving objects in the field of view of the said video cameras, then: an assumed trajectory of movement is constructed for each object detected in the frame of video data received by the first video camera, based on the analysis of the geometry of the object, and the same ID is assigned to the mentioned trajectory and the object itself; in the case when the constructed movement trajectory of at least one object does not intersect with the other movement trajectories of objects, based on the obtained movement trajectory of the object, the same object is detected in the frame of video data received from the second video camera, followed by assigning it the same ID corresponding to the trajectory of movement.

In another specific version of the stated solution, in the case when the constructed trajectories of several moving objects intersect, the following is performed: feature vectors for each moving object are constructed; the mentioned feature vectors of moving objects detected in the video data of neighboring/adjacent video cameras are compared pairwise; the same ID is assigned to the objects if the comparison result is greater than or equal to the threshold value previously set by the user.

In another specific version of the stated solution, additionally featured with the possibility of searching for objects, based on the search parameters set by the user.

In another specific version of the stated solution, additionally, on the basis of the resulting data received from the ANN, a postanalysis of the ID assignment history is performed to automatically correct errors when assigning IDs to objects in real time.

In another specific version of the stated solution, the mentioned postanalysis is started by the system automatically, with a certain time interval preset by the user, or is executed once the system user starts an object search.

In another specific version of the stated solution, the computer system additionally contains means for data input and output, allowing the system user to manually reassign object IDs.

In another specific version of the stated solution, the computer system additionally contains means for data input and output, allowing the system user to set object search parameters.

This technical result is also achieved by means of a computer-readable data carrier containing instructions executed by the computer processor for the implementation of methods for tracking the moving objects.

### BRIEF DESCRIPTION OF DRAWINGS

FIG. 1 - block diagram of a system for tracking the moving objects.

FIG. 2 - block diagram of the system operations depending on how many moving objects are detected in the field of view of the video cameras.

FIG. 3 - example of different trajectories of objects in the field of view of adjacent video cameras.

FIG. 4 - block diagram of an approximate implementation of a method for tracking moving objects, in the case when the areas of view of video cameras do not intersect.

### EMBODIMENT OF THE INVENTION

Description of the approximate embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The claimed technical solution in its various embodiment options can be implemented in the form of computing systems and methods implemented by various computer means, as well as in the form of a computer-readable data carrier, which stores the instructions executed by the computer processor.

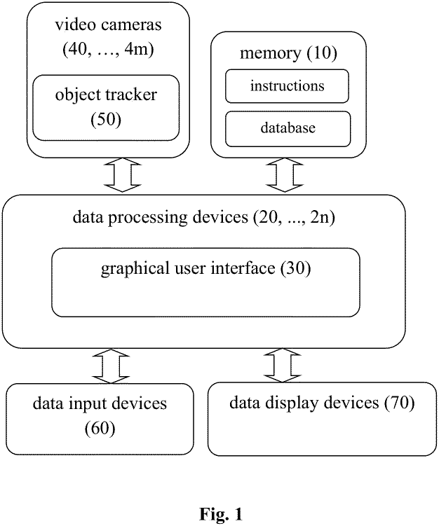

FIG. 1 shows a block diagram of a system for tracking the moving objects based on video data. This system includes: memory (10) configured to store video data and their metadata; at least one data processing device (20, ..., 2n), each containing a graphical user interface (30); and several video cameras (40, ..., 4m), each containing object tracker (50). Additionally, the system may include various data input devices (60), such as a keyboard, mouse, etc., as well as data display devices (70), for example, monitors. All components are connected to a single system over a local or global network (Internet) via a data bus.

In this context, systems may be any hardware- and software-based interconnected technical tools.

A computer system in turn can be a personal computer (PC), a tablet computer, a personal digital assistant (PDA), a cell phone, or any device capable of executing a set of instructions (sequential or otherwise) defining the actions to be performed by that device.

The video cameras are configured to receive real-time video data and its metadata and send it over the network to at least one data processing device. Thus, all video cameras of the system contain an object tracker (for example, AxxonSoft) configured to generate object metadata.

Object Tracker is a software algorithm for determining the location of moving objects in video data. By using the mentioned tracker, it is possible to detect all objects moving in the frame and determine their specific spatial coordinates. In the case when all video cameras of the system contain an object tracker, the video data and metadata received in real time can be immediately transmitted to the data processing device.

It should also be noted that metadata is detailed data about all objects moving in the field of view of each camera (locations, trajectories of movements, face descriptors, clothing descriptors, etc.).

The data processing device may be a processor, a microprocessor, a central processor, a graphics processor, a computer (an electronic computer), a PLC (a programmable logic controller), or an integrated circuit configured to execute certain commands (instructions, programs) for data processing. A graphical user interface is installed on each data processing device.

The graphical user interface (GUI) is a system of data input and output tools for user interaction with a computing device based on the representation of all system objects and functions available to the user in the form of graphical components of the screen (windows, icons, menus, buttons, lists, etc.). Thus, the user has random access via data input/output devices to all visible screen objects —interface units — which are displayed on the display. The data input/output device can be, but is not limited to, mouse, keyboard, touchpad, stylus, joystick, trackpad, etc.

Memory devices configured to store data may include, but are not limited to, hard disk drives (HDD), flash memory, static random access memory (SRAM), server, ROM (read only memory), solid-state drives (SSD), optical storage devices, random access memory (RAM) (e.g., ROM, dynamic RAM (DRAM), synchronous dynamic RAM (SDRAM)), or any combination thereof.

The memory may store a database (DB) containing video data and corresponding metadata received from the system’s video cameras. Memory may also store instructions that force the data processing device to perform certain operations.

It should be noted that the described system may include any other devices known in the background, for example, such as various types of sensors, input/output devices, display devices, etc.

An example of the operation of the above-mentioned system for tracking the moving objects will be described in detail below. All the stages of the system operation described below in its various configurations are also applicable to the corresponding options for tracking the moving objects, which will be described in more detail below.

Let’s consider the principle of operation of the claimed system for tracking the moving objects.

Let’s assume that the system is installed on a large area, let’s say on the territory of a big city. That is, in this case, there is at least one dispatch center (with data processing devices installed there), and there are many video cameras connected to the system, data from which is sent to the device or data processing devices in real time.

In order for the system to function with proper accuracy, speed and quality, certain conditions must be met, which require the user to perform certain actions using the system’s GUI tools.
1. All video cameras should contain an object tracker (it can be any tracker, for example, AxxonSoft). It should be noted that most modern video cameras contain a built-in object tracker that can be used in the claimed system.
2. All video cameras of the system should be linked to the terrain map. For this purpose, the user of the system, using the means of the system’s GUI, links each video camera to the terrain map. Namely, the user of the system puts the camera icon at a certain point on the map (this point corresponds to the coordinates of the real location of the camera). After that, the data processing device assigns a specific location to a specific video camera.
3. All video cameras of the system should be calibrated. Accordingly, it is necessary to calibrate the camera on the map (all details of the calibration of video cameras are described in detail in our earlier Pat. RU 2679200 C1, publ. Febuary 16, 2019).

In general, camera calibration means the assignment of internal and external parameters of the camera based on the existing images or video captured by it. Camera calibration is often used at the initial stage of solving many computer vision problems. Camera calibration helps to correct distortion in images and video data.

During calibration, at least four virtual segments are determined on the map and the frame of the image under consideration, characterizing the coordinates of the location of a stationary object in space. The connections between them are set, while one end of each segment corresponds to the location of a stationary object in the frame and the other end of the segment corresponds to the location of the object on the terrain map. For calibrated cameras, matching of the object image position with their position on the terrain map is marked.

Terrain map is a type of topographic map or drawing of a small area at a given scale, which is an image in a publicly-accessible format. Interactive maps are now widely used.

In general, an interactive map is an electronic map that presents information linked to a geographical context. In the context of this application, an interactive map is a terrain plan or an open terrain map (OpenStreetMap). OpenStreetMap is configured based on the data of the geographic information system (GIS), while it is possible to edit it (depending on the requirements and interests of the user). Thus, in the case when the interactive map is an OpenStreetMap, it is possible to specify the exact coordinates of its location in the settings of each video camera. After that, each video camera will be added to the interactive map at a preset point (snap).

Thus, in the context of the described embodiment of the invention, all the video cameras of the system are linked to the said interactive map, while the video cameras are calibrated and contain an object tracker. When all the specified conditions for the correct operation of the system are met, the video surveillance system can start operation, that is, detecting and tracking the objects moving in the frame. It is easy to perform further search in the system for the detected objects.

The main operation is performed by at least one data processing device, for example, such as a computer processor. The mentioned data processing device (one or multiple) receives video data in real time from the mentioned video cameras. Similarly, the data processing device can receive metadata (corresponding to the received video data).

According to the data obtained, an analysis of moving objects is performed, on the basis of which all moving objects in the protected area of the system are detected. This analysis can be performed both in real time and with the archived data of the system.

As an example, let’s consider one/first video camera with one moving object detected in its video data frame. It should be noted that the system is configured to detect all objects moving in the frame at once (such situations will be described below). However, we will focus on a detailed description of the detection of one object for to easily understand the essence of the invention. All subsequent objects in the frame are detected in the same way. It is also important to note that there are such periods of time when there may be no moving objects at all in the field of view of the video camera. This is a normal situation in which the system continues to function. And when a moving object is detected, the system proceeds to follow-up actions.

After a moving object is detected, a unique identification number (ID) is assigned to it by the data processing device. This ID is inherent to a specific moving object as long as the object is in the field of view of the first video camera.

However, our goal is to correlate the same moving object in the field of view of several video cameras. To achieve this goal, the processor performs the next step, namely, analyzes the movement geometry of a moving object detected in the frame.

Geometry analysis refers to the analysis of the object’s past trajectory, as well as the analysis of the nature of changes in its size and speed of movement. In other words, “analysis” means the search for a model that describes and predicts the trajectory and dimensions of an object well at the next moment in time. The analysis is performed on the basis of the entire period of object tracking on the scene, that is, all the time it is determined in the field of view of one camera. Accordingly, the time interval of the analysis is a dynamic value and depends on the period spent by a particular object in the field of view of the camera.

Based on the results of the analysis, the object movement direction is evaluated. That is, the system suggests in which direction the object will move and at what speed, on the basis of which it is possible to predict the second video camera (or several video cameras), in the area of view of which the mentioned moving object may appear. Thus, the next stage is aimed at predicting the second video camera (more information about the prediction of video cameras is disclosed in our earlier Pat. RU 2670429 C1, publ. Oct. 23, 2019).

Thus, it should be noted that there is a certain threshold allowable time of absence of an object in the vicinity of the prediction location (in the field of view of the predicted video camera), after which the track ends, and does not continue under the same ID. This threshold time is calculated dynamically based on the nature of the object’s motion law. That is, if the object was moving fast, then it is given less time to move to the prediction point, and if it was moving slowly, then this time increases. Thus, if an object appears in a certain vicinity of the prediction location in the specified/calculated time range, then it continues under the previous ID and if it does not appear, then the old track is considered completed and the newly appeared object will have a new ID.

The interconnection of several video cameras implies that the system performs a “global analysis” that takes into account the characteristics of the size and movement of an object when moving between several video cameras. The global analysis continues as long as it is possible to track the movement of one object by cameras of the system.

Further, the implementation of the invention will vary depending on whether there are intersections of the areas (fields) of view of video cameras. It should be noted that the video surveillance system may include various video cameras. That is, the areas of view of some video cameras will intersect (adjacent video cameras), while the areas of view of others will not intersect (and they may be adjacent or randomly located). In order to take into account all these nuances, let’s take a closer look at each individual option.

The areas of view of the system’s video cameras do not overlap.

In this case, an artificial neural network is used to compare objects from adjacent video cameras. For example, an object was detected in the field of view of the first video camera. Then, after some time, the object leaves the field of view of this video camera and appears in the field of view of another (second) video camera. Thus, the direction of movement of the detected object suggested its appearance precisely in the field of view of the second video camera.

Thus, the next step of the data processing device is the detection of at least one object in the field of view of the second video camera after the object has left the field of view of the first video camera. When at least one object is detected in the field of view of the second video camera, the first vector of features of the object detected in the frame from the first video camera and the second vector of features of the object detected in the frame from the second video camera are built based on the use of the ANN. The first and second vectors of the object’s features mentioned below are compared.

Based on the result of comparing feature vectors, the object detected in the frame of the second video camera is automatically assigned the same ID as the object detected in the frame of the first video camera, if the comparison result is greater than or equal to the threshold value previously set by the user. If the comparison result is less than the threshold value, then another (new) ID is assigned to the object detected in the field of view of the second video camera. The user can set a threshold value before or during the operation of the system (for example, a value of 0.9, which corresponds to a 90% coincidence of vectors).

Let’s take a closer look at operation of the neural network. It should be noted that different networks can be used, including but not limited to: OSNet -Omni Scale Net, Siamese Neural Network, Detection Network, Classical Classification Network, Skeletonization Network, etc. Let’s focus on a detailed examination of the artificial neural network used in the claimed solution.

The network receives an RGB image with a size of 256×128, in NCHW format (where N is the number of images, C is the number of channels in the image, H is height, W is width), normalized according to the ImageNet standard. Normalization involves subtracting the average values for each of the 3 channels (123.675, 116.28, 103.53) and dividing by the deviation of each channel (58.395, 57.12, 57.375). At the output of the network, a vector with a dimension of 256 elements is obtained, containing relevant information about the visual features of the object in the image, such as clothing or the presence/absence of various attributes (bags, hats, etc.). The resulting vector is used for subsequent comparison with vectors from other objects in order to determine the degree of similarity between objects and assign the correct ID to objects.

The network used is characterized by the presence and use of the following set of layers:

Table 1

| No. | Layers |
|---|---|
| 1 | convolutional layers |
| 2 | batch normalization layers |
| 3 | instance normalization layers |
| 4 | group normalization layers |
| 5 | ReLU activation layers |
| 6 | PReLU activation layers |
| 7 | MaxPooling layers |
| 8 | AveragePooling layers |
| 9 | Sigmoid activation layers |
| 10 | linear layers |

In the context of this solution, we can outline the following stages of neural network operation:
1. An instance normalization with affine transformation is applied to the input image/frame, after which, using a block consisting of convolution, instance normalization (also with affine transformation), ReLU activation, and a MaxPooling layer, the basic features of the object (feature map), such as contours, angles, etc., are extracted.
2. The obtained feature maps are sequentially applied to special network blocks (three in total), which contain single-channel convolutions, four sub-blocks with a different number of channel-by-channel convolutions (from 1 to 4), and an aggregation mechanism with parameters shared within one block. The aggregating mechanism, in turn, consists of an AveragePooling layer, a group normalization layer and a Sigmoid activation layer, while the aggregating mechanism receives input signs obtained after applying a different number of channel-by-channel convolutions (like the Inception blocks in GoogLeNet). Blocks enable extracting global features of an object (feature map) from various scales and filtering out background features.
3. Single-channel convolution and channel-by-channel convolution with a filter dimension equal to the size of feature maps are applied to the resulting set of feature maps (basic features and global features). This stage is needed to convert feature maps into a one-dimensional vector of fixed size. The resulting vector contains global features of the object in the image. However, for a deeper analysis of the existing features, the next stage of processing is performed, because if no further transformations are made, the result of the vector comparison will be less correct.
4. A block consisting of a linear layer, batch normalization, and PReLU activation is applied to the resulting vector. This stage enables extracting local features of the object. That is, a nonlinear transformation is applied to a vector with global features, which allows, in addition to global features, to additionally consider local features for comparison (which increases the accuracy of the subsequent comparison).

Thus, the output of the network is a vector with a dimension of 256 elements, which contains current information about the visual characteristics of the object in the image. The resulting vector is used for subsequent comparison with vectors from other objects. Moreover, the comparison can be performed both by standard means of a data processing device and by using an ANN. The vector comparison operation is a standard operation and does not require a separate explanation.

The data processor (or neural network) compares objects and if the percentage of matching is higher than the threshold value, then the system considers that it is the same object and, therefore, the same ID will be used for it.

It should also be noted that a neural network can be learned to calculate feature vectors for any type of objects, such as, but not limited to: human, vehicle, animal, item, thing, etc. However, it is more appropriate to use different neural networks for each type of objects, since individual network learning is required for each type.

Let’s consider the following situation when the camera’s field of view intersects. That is, the video cameras are adjacent.

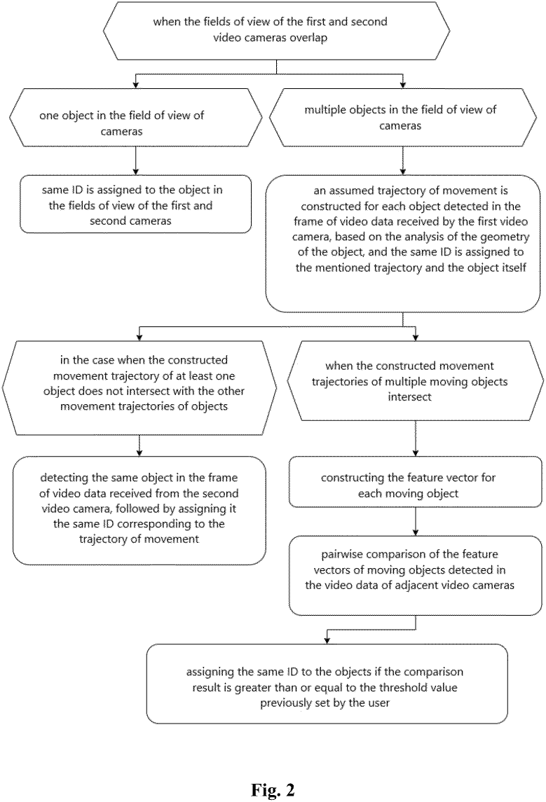

In this case, there are several scenarios and, accordingly, variants of operation of the system. FIG. 2 shows a block diagram of the system’s operations depending on how many moving objects are detected in the field of view of the first and second video cameras.

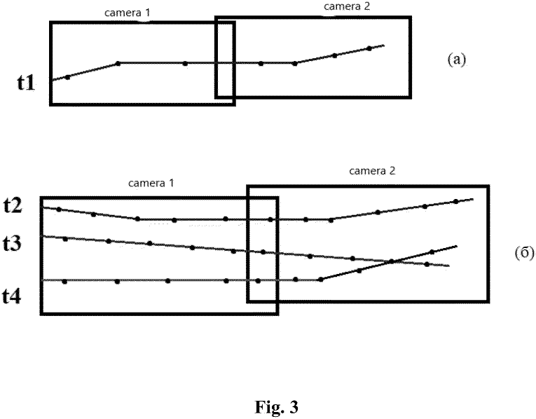

The simplest case is when only one moving object appears in the field of view of adjacent video cameras. This object is recognized by the system (and the algorithm) as the same object. That is, the system automatically assigns the same ID to this object. For greater clarity, FIG. 3 shows an example of various trajectories of objects in the field of view of adjacent video cameras. As can be seen in FIG. 3 (a) -in the field of view of adjacent video cameras (camera 1 and camera 2), there is only one moving object, with a trajectory t1. Accordingly, the same ID is assigned to this object and its trajectory.

But in the case when there are several moving objects in the field of view of adjacent video cameras, the operation of the system becomes more complicated.

In this case, an assumed trajectory is built for each object detected in the frame of video data received by the first video camera, based on the analysis of the geometry of the object’s movement. In FIG. 3 (b) we can see three movement trajectories for three different objects - t2, t3 and t4.

In the context of this application, a trajectory is a set of points/coordinates (in 2 or 3 dimensional space, depending on the source data) with an indication of their times. In this case, the points can be obtained from several video cameras. It should also be noted that the trajectory of movement and the object itself are assigned the same ID (that is, the object has one single ID and one single trajectory, with the same ID).

In the case when the built movement trajectory of at least one object does not intersect with the other movement trajectories of objects, based on the obtained movement trajectory of the object, the same object is detected in the frame of video data received from the second video camera, followed by assigning it the same ID corresponding to the trajectory of movement. As shown in FIG. 3 (b) , the trajectory of the second object t2 does not intersect with the other objects in the field of view of the presented adjacent video cameras.

But in a more complex case, when the built movement trajectories of several moving objects intersect (that is, in the event of a collision), similar operations are performed based on the use of the ANN described above (for the case when the areas of view of video cameras do not intersect). For clarity, FIG. 3 (b) shows the intersecting trajectories of objects t3 and t4.

The feature vectors of each moving object are constructed using the ANN (as described in detail above). Then, a pairwise comparison of the mentioned feature vectors of moving objects detected in the video data of neighboring/adjacent video cameras is performed. The comparison can be performed both by standard means of a data processing device and with the use of neural network resources. Next, objects are assigned the same ID if the result of the comparison is greater than or equal to a threshold value previously set by the user (for example, a threshold of 0.96). And, accordingly, a different ID is assigned, if the comparison result is less than the threshold.

The system features should be considered too.

In one of the particular embodiment options, the system additionally performs a postanalysis of the history, which corrects errors. That is, based on the resulting data received from the ANN and the processor, a postanalysis of the ID assignment history is performed to automatically correct errors when assigning IDs to objects in real time.

The essence of the above-mentioned postanalysis is that the ID can be assigned to an object incorrectly in online mode, as the system does not yet have feature vectors and the results of their comparisons. In the case when there is a complex movement of several objects in the frame, whose trajectories intersect, the probability of an error in real time increases. However, after receiving data from the neural network, the data processing device can reassign the object IDs to the correct ones.

In addition, in one of the embodiment options, the system contains means for data input and output, allowing the system user to manually reassign object IDs in case the user believes that the system has made an error. For example, there may be situations when the operator /user of the system sees that both the system and the ANN have worked incorrectly. In this case, the system user can manually (with help of the system’s GUI tools) indicate that the moving object in the field of view of the first video camera and the object in the field of view of the second video camera is the same object. Therefore, this object should have the same ID. Thus, if the user is sure a system has made error, then they can easily fix it.

It should also be noted that the above-mentioned postanalysis is started by the system either automatically, each (certain) period of time previously set by the user (for example, a few minutes after the object is moved, if there are many objects in the frame, 10-15 minutes if the movement is not intense). ALternatively, the postanalysis can be performed directly at the moment when the system user starts a search for objects or some other operation of video data analysis.

In addition, the claimed solution allows the operator / user of the system to significantly / enormously save time during investigations. To do this, the system additionally contains data input and output tools that allow the system user to set object search parameters and launch the mentioned object search. Accordingly, the system is configured to perform object search based on user-defined search parameters/characteristics.

For example, if an object of interest has come into the field of view of a video camera, then the user can highlight/select it, assign any search criteria/parameters (from those available in the system), specify the time interval of the search and the system will output videos from all other video cameras that have this object in the field of view for a preset period of time. More information about the search and search criteria is disclosed in our earlier Pat. RU 2710308 C1, publ. Dec. 25, 2019).

In general, three search modes are considered: search by faces (1), search by vehicle numbers (2), or search by objects (3). Object search mode is a more general mode, but its use is often more efficient. For the mentioned object search mode, the user can set all characteristics of the object known to them in GUI. The object characteristics include: object type, object color, object minimum size, object maximum size, etc. The object types include: a person, a group of people, a vehicle, a left item or thing, etc.

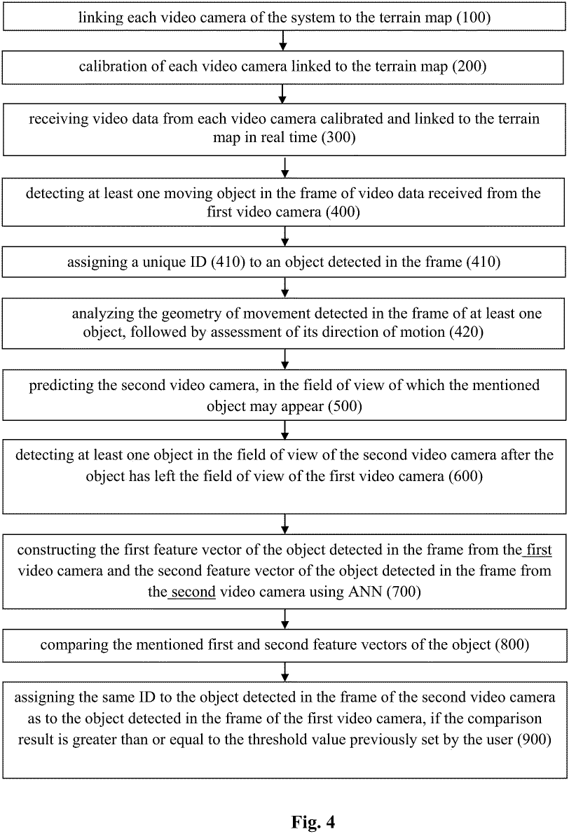

An example of a specific embodiment of the method will be described below. FIG. 4 shows a block diagram of one of the embodiment options of a method for tracking moving objects using video data, in the case when the field of view of video cameras do not intersect.

This method is performed by the above-described computer system containing at least a data processing device, memory, and several video cameras connected over a network. Thus, the method contains the stages at which te following operations are performed:
(100) linking each video camera of the system to the terrain map;
(200) calibration of each video camera linked to the terrain map;
(300) receiving video data from each video camera calibrated and linked to the terrain map in real time;
(400) detecting at least one moving object in the frame of video data received from the first video camera;
(410) assigning a unique identification number (ID) to this object detected in the frame;
(420) analyzing the geometry of movement detected in the frame of at least one object, followed by assessment of its direction of motion;
(500) predicting the second video camera, in the field of view of which the mentioned object may appear;
thus, in the case when the field of view of the first and second video cameras do not intersect, the following operations are performed:
(600) detecting at least one object in the field of view of the second video camera after the object has left the field of view of the first video camera;
(700) constructing the first feature vector of the object detected in the frame from the first video camera and the second feature vector of the object detected in the frame from the second video camera using artificial neural network (ANN);
(800) comparing the mentioned first and second feature vectors of the object;
(900) assigning the same ID to the object detected in the frame of the second video camera as to the object detected in the frame of the first video camera, if the comparison result is greater than or equal to the threshold value previously set by the user.

It should be noted once again that the above options of methods can be implemented using the above-described corresponding computing systems. Consequently, the method can be expanded and refined by all particular versions that have already been described above for implementation of the system for tracking the moving objects.

In addition, embodiments of this group of inventions can be implemented using software, hardware, software logic, or a combination thereof. In this implementation example, program logic, software, or a set of instructions are stored on one or more of the various traditional computer-readable data carriers.

In the context of this description, a “computer-readable data carrier” can be any medium or means that can contain, store, transmit, distribute, or transport instructions (commands) for their use (execution) by a computing system, for example, such as a computer. In this case, the data carrier may be a non-volatile machine-readable data carrier.

It should also be noted that the terms “first” and “second” video cameras, etc., are introduced into the context of this description. These terms are intended to denote various elements and do not necessarily have an ordinal value in accordance with their numerical designation. The interaction disclosed in the description between the first and second video cameras can be similarly performed for any two video cameras of the system, regardless of their serial number.

Any aspect or solution described in this document as an “example” or “given as an example” should not be considered preferable or preferential over other aspects or solutions. The use of the word “example” is intended rather to present concepts from a practical point of view.

If necessary, at least part of the various operations discussed in the description of this solution can be performed in a different order from the one presented and/or simultaneously with each other.

While this technical solution has been described in detail to illustrate the embodiments that are most necessary and preferred at present, it should be understood that this invention is not limited to the embodiments disclosed and, moreover, is intended to modify and combine various other features from the embodiments described. For example, it should be understood that the present invention assumes that, to the extent possible, one or more features of any embodiment can be combined with another one or more features of any other embodiment.

1. The system for tracking the moving objects containing:
memory configured to store video data and its metadata;
several video cameras configured to receive real-time video data from the control area, each with an object tracker;
at least one data processing device configured to perform steps including:
linking each video camera of the system to the terrain map;
calibration of each video camera linked to the terrain map;
receiving video data from each video camera calibrated and linked to the terrain map in real time;
detecting at least one moving object in the frame of video data received from the first video camera;
assigning a unique identification number (ID) to this object detected in the frame;
analyzing the geometry of movement detected in the frame of at least one object, followed by assessment of its direction of motion;
predicting the second video camera, in the field of view of which the mentioned object may appear;
thus, in the case when the field of view of the first and second video cameras do not intersect, the following operations are performed:
detecting at least one object in the field of view of the second video camera after the object has left the field of view of the first video camera;
constructing the first feature vector of the object detected in the frame from the first video camera and the second feature vector of the object detected in the frame from the second video camera using artificial neural network (ANN);
comparing the mentioned first and second feature vectors of the object;
assigning the same ID to the object detected in the frame of the second video camera as to the object detected in the frame of the first video camera, if the comparison result is greater than or equal to the threshold value previously set by the user.

2. The system according to claim 1, in which, when the fields of view of the first and second video cameras intersect, and if only one moving object appears in the field of view of the said video cameras, the same ID is automatically assigned to this obj ect.

3. The system according to claim 1, in the case when the fields of view of the first and second video cameras intersect, and if there are several moving objects in the field of view of the said video cameras, then:
an assumed trajectory of movement is constructed for each object detected in the frame of video data received by the first video camera, based on the analysis of the geometry of the object, and the same ID is assigned to the mentioned trajectory and the object itself;
in the case when the constructed movement trajectory of at least one object does not intersect with the other movement trajectories of objects, based on the obtained movement trajectory of the object, the same object is detected in the frame of video data received from the second video camera, followed by assigning it the same ID corresponding to the trajectory of movement.

4. The system according to claim 3, in the case when the constructed trajectories of several moving objects intersect, the following is performed:
feature vectors for each moving object are constructed;
the mentioned feature vectors of moving objects detected in the video data of neighboring/adjacent video cameras are compared pairwise;
the same ID is assigned to the objects if the comparison result is greater than or equal to the threshold value previously set by the user.

5. The system according to claim 1, additionally configured to perform object search based on user-defined search parameters.

6. The system according to claim 1, in which additionally, on the basis of the resulting data received from the ANN, a postanalysis of the ID assignment history is performed to automatically correct errors when assigning IDs to objects in real time.

7. The system according to claim 6, wherein the mentioned postanalysis is started by the system automatically, with a certain time interval preset by the user, or is executed once the system user starts an object search.

8. The system according to claim 1, additionally containing means for data input and output, allowing the user of the system to manually reassign object IDs.

9. The system according to claim 5, additionally containing means for data input and output, allowing the user of the system to set object search parameters and launch the mentioned object search.

10. The method for tracking the moving objects performed by a computer system containing at least a data processing device, memory and several video cameras, while the method contains the steps at which the following operations are performed:
linking each video camera of the system to the terrain map;
calibration of each video camera linked to the terrain map;
receiving video data from each video camera calibrated and linked to the terrain map in real time;
detecting at least one moving object in the frame of video data received from the first video camera;
assigning a unique identification number (ID) to this object detected in the frame;
analyzing the geometry of movement detected in the frame of at least one object, followed by assessment of its direction of motion;
predicting the second video camera, in the field of view of which the mentioned object may appear;
thus, in the case when the field of view of the first and second video cameras do not intersect, the following operations are performed:
detecting at least one object in the field of view of the second video camera after the object has left the field of view of the first video camera;
constructing the first feature vector of the object detected in the frame from the first video camera and the second feature vector of the object detected in the frame from the second video camera using artificial neural network (ANN);
comparing the mentioned first and second feature vectors of the object;
assigning the same ID to the object detected in the frame of the second video camera as to the object detected in the frame of the first video camera, if the comparison result is greater than or equal to the threshold value previously set by the user.

11. The method according to claim 10, when the fields of view of the first and second video cameras intersect, and if only one moving object appears in the field of view of the said video cameras, the same ID is automatically assigned to this object.

12. The method according to claim 10, in the case when the fields of view of the first and second video cameras intersect, and if there are several moving objects in the field of view of the said video cameras, then:
an assumed trajectory of movement is constructed for each object detected in the frame of video data received by the first video camera, based on the analysis of the geometry of the object, and the same ID is assigned to the mentioned trajectory and the object itself;
in the case when the constructed movement trajectory of at least one object does not intersect with the other movement trajectories of objects, based on the obtained movement trajectory of the object, the same object is detected in the frame of video data received from the second video camera, followed by assigning it the same ID corresponding to the trajectory of movement.

13. The method according to claim 12, in the case when the constructed trajectories of several moving objects intersect, the following is performed:
feature vectors for each moving object are constructed;
the mentioned feature vectors of moving objects detected in the video data of neighboring/adjacent video cameras are compared pairwise;
the same ID is assigned to the objects if the comparison result is greater than or equal to the threshold value previously set by the user.

14. The method according to claim 10, additionally featured with the possibility of searching for objects, based on the search parameters set by the user.

15. The method according to claim 10, additionally, on the basis of the resulting data received from the ANN, a postanalysis of the ID assignment history is performed to automatically correct errors when assigning IDs to objects in real time.

16. The method according to claim 15, wherein the the mentioned postanalysis is started by the system automatically, with a certain time interval preset by the user, or is executed once the system user starts an object search.

17. The method according to claim 10, wherein the computer system additionally contains means for data input and output, allowing the system user to manually reassign object IDs.

18. The method according to claim 14, wherein the computer system additionally contains means for data input and output, allowing the system user to set object search parameters.

19. A computer-readable data carrier containing instructions executed by the computer processor for the implementation of methods for tracking the moving objects according to claim 10.
